(19) United States
(12) Patent Application Publication
(10) Pub. No.: US 2025/0369135 A1
(43) Pub. Date: Dec. 4, 2025

(54) NAFION AND METAL ORGANIC FRAMEWORK COMPOSITE ELECTRODE FOR ALKALINE HYDROGEN EVOLUTION REACTION AND MANUFACTURING METHOD THEREOF

(71) Applicant: POSTECH RESEARCH AND BUSINESS DEVELOPMENT FOUNDATION, Pohang-si (KR)

(72) Inventors: Yong Tae KIM, Pohang-si (KR); In Ho BAEK, Pohang-si (KR); Sang Mun JUNG, Pohang-si (KR)

(21) Appl. No.: 19/013,126

(22) Filed: Jan. 8, 2025

(30) Foreign Application Priority Data
May 28, 2024 (KR) 10-2024-0069031

(51) Int. Cl. C25B 11/095; C25B 9/19; C25B 11/032

(52) U.S. Cl. CPC C25B 11/095; C25B 9/19; C25B 11/032

(57) ABSTRACT

The present invention relates to an electrode for a hydrogen evolution reaction in an alkaline water electrolysis cell, wherein the electrode comprises: a co-catalyst consisting of a composite containing a Lewis acid-containing material and a metal-organic framework (MOF); and a catalyst surrounded by the co-catalyst. According to the present invention, the water dissociation step of the alkaline hydrogen evolution reaction is promoted, hydrogen gas generated by the hydrogen evolution reaction can easily permeate through the structure, and Nafion is uniformly dispersed by the large pores created by the MOF, thereby implementing the co-catalyst effect across the entire surface while minimizing catalyst poisoning.

### TECHNICAL FILED

The present invention relates to an electrode for alkaline hydrogen evolution reaction and its manufacturing method. More specifically, it relates to an electrode for alkaline hydrogen evolution reaction and its manufacturing method that employs a catalyst comprising a Nafion and Metal Organic Framework (MOF) composite, which is highly effective for water activation.

### BACKGROUND

Hydrogen does not exist independently in nature but predominantly exists in the form of compounds bonded with various elements. Consequently, it must undergo a separate production process to be converted into an energy source. The primary methods of hydrogen production include: by-product hydrogen, which is generated as a secondary product during petrochemical processes or steel manufacturing; reformed hydrogen, produced by decomposing natural gas under high-temperature and high-pressure conditions; and water electrolysis, which generates hydrogen through the electrolysis of water. Water electrolysis is an environmentally friendly method as it emits no carbon dioxide during the hydrogen extraction process, making it a highly promising technology in the carbon-neutral era.

Among these methods, Alkaline Water Electrolysis (AEC) employs an alkaline electrolyte solution to electrolyze water. As the most commercialized water electrolysis technology, with a long history of research, it offers the significant advantage of operational stability. Recently, research has focused on water electrolysis technologies that incorporate metal oxides, chalcogens, and halogens as co-catalysts to accelerate the water dissociation step in the alkaline hydrogen evolution reaction, thereby reducing activation losses.

However, co-catalysts based on metal oxides and chalcogen/halogen elements have inherent limitations. Their activity is maximized only on the catalyst surface adjacent to the co-catalyst, while other areas of the catalyst surface that could facilitate reactions may become partially deactivated. This limitation highlights the need for a new paradigm in catalyst design to minimize activation losses during the alkaline water dissociation step. Furthermore, the use of metal oxide-, chalcogen-, and halogen-based co-catalysts necessitates the development of new synthesis methods and compositions tailored to the specific types of catalysts, which poses additional challenges.

### SUMMARY OF INVENTION

The present invention addresses the problem of providing an electrode for the alkaline hydrogen evolution reaction (HER), which includes a composite of Nafion and MOFs, to efficiently promote the water dissociation step in the alkaline hydrogen evolution reaction.

Specifically, the invention provides an electrode for alkaline HER that facilitates the permeation of hydrogen gas generated during the reaction by incorporating MOFs with Nafion. The large pores formed by the MOFs enable uniform dispersion of Nafion, thereby achieving co-catalytic effects across the entire surface while minimizing catalyst poisoning.

The scope of the problems addressed by the present invention is not limited to those explicitly mentioned above. Additional problems not described herein will become apparent to those of ordinary skill in the art from the detailed description provided below.

To address the challenges described above, an electrode for a hydrogen evolution reaction in an alkaline water electrolysis cell according to one embodiment of the present invention may comprise a co-catalyst comprising a composite including a Lewis acid-containing material and a metal-organic framework (MOF); and a catalyst surrounded by the co-catalyst.

In this case, the Lewis acid-containing material comprises at least one selected from Nafion, HCl, HNO₃, carboxylic acid, phenol, alcohol, Li⁺, Mg²⁺, and AlCl₃

In one aspect, the metal-organic structure may have a pore size of 6 Å or more.

In one aspect, the metal-organic framework is selected from the group consisting of Zr-UiO-66, Ti-MIL-125, Zn-ZIF-69, Zr-UiO-66 octahedral, Zn-ZIF-78, Zn-ZIF-79, Zn-ZIF-81, AL-MIL-53-NH3, Zr-UiO-68, Zn-MOF-74, Zn-ZIF-68, Zn-ZIF-80, Zr-UiO-67, Zn-ZIF-80, Zn-ZIF-82, Al-MIL-53, Zn-ZIF-70, Cu-MOF-74, and Cr-MIL-101.

Furthermore, wherein the mass ratio of the catalyst to the metal-organic framework is 1:10 or less.

Further, the catalyst comprises at least one selected from the group consisting of Pt/C, Nickel Nano powder, NiMo/C, Ni-based catalysts, Cu-based catalysts, and Co-based catalysts.

According to another embodiment of the present invention, in an alkaline water electrolysis cell comprising an end plate, a collector plate, an anode, a cathode, a porous transport layer, and a separator, according to an embodiment of the present invention, the cathode comprises a co-catalyst comprising a composite including a Lewis acid-containing material and a metal-organic framework (MOF); and a catalyst surrounded by the co-catalyst.

Specific details of other embodiments are included in the detailed description and drawings.

According to an embodiment of the present invention, the Nafion/Cr-MIL-101 co-catalyst combination significantly reduced the overpotential of the Pt/C catalyst at 10 mA/cm² (from 96 mV to 45 mV). This substantial improvement in the catalytic performance of the hydrogen evolution reaction in an alkaline environment, which typically shows lower activity compared to acidic conditions, is expected to accelerate the commercialization of water electrolysis technology in alkaline systems.

Furthermore, the present invention demonstrates that loading various MOF materials beyond Cr-MIL-101 can enhance the hydrogen evolution reaction performance in alkaline water electrolysis cells. The present invention also confirms that this co-catalyst combination is effective not only with Pt/C catalysts but also with other hydrogen evolution reaction catalysts. Notably, The present invention has led to the development of a versatile electrode fabrication method that can be universally applied in the production of hydrogen evolution reaction electrodes.

Therefore, the present invention provides an electrode for alkaline hydrogen evolution reaction comprising a Nafion-MOF composite, which efficiently promotes the water dissociation step in the alkaline hydrogen evolution reaction.

Furthermore, the present invention may provide an electrode for alkaline hydrogen evolution reaction that can easily permeate hydrogen gas generated by the hydrogen evolution reaction, evenly disperse Nafion by the large pores generated by the MOF, and minimize catalyst toxicity while realizing the effect of a co-catalyst on the entire surface.

The effects of the present invention are not limited to the examples described above, and additional effects will be apparent to those skilled in the art from the following detailed description.

### BRIEF DESCRIPTION OF DRAWINGS

FIG. 1 is a schematic diagram of an electrode for a hydrogen evolution reaction and a reaction at the electrode according to an embodiment of the present invention.

FIG. 2 is a diagram of the pore size of a MOF.

FIG. 3 shows voltage versus current density plots for a nickel nano powder catalyst with MOF-containing co-catalyst according to an embodiment of the present invention.

FIG. 4 shows performance improvements as to catalyst-to-MOF ratio according to an embodiment of the present invention.

FIG. 5 shows performance improvements for different MOF materials according to an embodiment of the present invention.

FIG. 6 shows performance improvements as to NiMo/C catalyst-to-MOF ratio according to an embodiment of the present invention.

FIG. 7 shows a schematic diagram of an exemplary anion exchange membrane water electrolysis (AEMWE) cell according to an embodiment of the present invention.

FIG. 8 shows performance improvements in an actual water electrolysis cell according to an embodiment of the present invention.

FIG. 9 shows performance improvements when using nickel nano powder as a catalyst with MOF-containing co-catalyst in an actual water electrolysis cell according to an embodiment of the present invention.

FIG. 10 shows performance improvements as to catalyst-to-MOF ratio in an actual water electrolysis cell according to an embodiment of the present invention.

FIG. 11 shows performance improvements as to Nafion content in an actual water electrolysis cell according to an embodiment of the present invention.

FIG. 12 shows a schematic diagram of a hydrogen evolution reaction electrode and its reaction mechanism according to the prior art.

### DETAILED DESCRIPTION OF THE EMBODIMENTS

The embodiments of the present application will be described in more detail with reference to the accompanying drawings. However, the technology disclosed in this application is not limited to the embodiments described herein and may be embodied in other forms. The embodiments presented here are provided to ensure that the disclosure is thorough and complete, and to fully convey the ideas of the present application to those skilled in the art. In the drawings, the dimensions of components, such as width or thickness, may be somewhat enlarged or reduced to clearly represent the components of each device.

Also, while only a portion of a component may be shown for ease of explanation, those skilled in the art will readily understand the remaining portions. Throughout, the drawings are described from an observer's perspective, and when an element is described as being located above or below another element, this means either that the element may be directly above or below the other element, or that additional elements may be interposed between them.

Furthermore, those skilled in the art will be able to implement the ideas of the present application in various other forms without departing from its technical scope. And throughout the multiple drawings, like reference numerals refer to substantially identical elements.

Additionally, singular expressions should be understood to include the plural unless the context clearly indicates otherwise, and terms such as “include” or “have” are intended to indicate the presence of described features, numbers, steps, actions, components, parts, or combinations thereof, without precluding the possibility of the presence or addition of one or more other features, numbers, steps, actions, components, parts, or combinations thereof.

Furthermore, when carrying out a method or manufacturing process, unless the context clearly indicates a particular order, the steps comprising the method may occur in a different order than specified—they may occur in the specified order, substantially simultaneously, or in the reverse order.

Various embodiments of the present invention will now be described in detail with reference to the accompanying drawings.

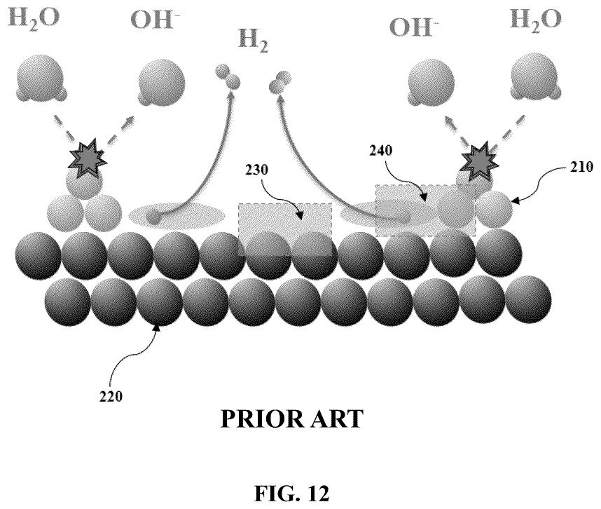

First, let us examine the limitations of the prior art with reference to FIG. 12. FIG. 12 shows a schematic diagram of a hydrogen evolution reaction electrode and its reaction mechanism according to the prior art. As shown in FIG. 12, the electrode for hydrogen evolution reaction includes a co-catalyst 210 and a catalyst 220. In this case, the co-catalyst 210 comprises a metal oxide and a chalcogen or halogen element and is used to induce water dissociation. In this case, catalyst region 230 not adjacent to the co-catalyst 210 does not receive the co-catalyst's effect, which reduces the occurrence of reactions. Additionally, while catalyst surface region 240 adjacent to the co-catalyst shows maximized activity, they have the limitation of partially poisoning the catalyst surface where reactions can occur.

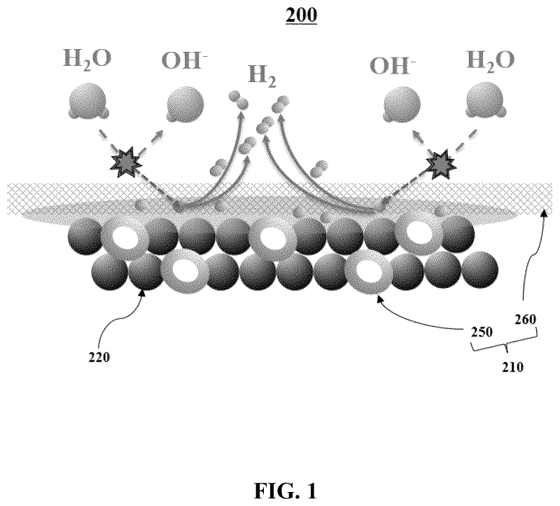

Referring to FIG. 1, in order to address these problems, an electrode 200 for hydrogen evolution reaction in an alkaline water electrolysis cell according to the present invention includes a co-catalyst 210 and a catalyst 220. The co-catalyst 210 comprises a composite containing a Lewis acid-containing material 250 and a metal organic framework (MOF) 260. Preferably, the catalyst material, Lewis acid-containing material, and metal organic framework powder are mixed and blended together, ensuring uniform distribution of all materials on the surface to maximize the catalytic and co-catalytic effects.

In this case, the Lewis acid-containing substance 250 of the co-catalyst 210 can utilize Nafion, and the embodiments primarily focus on the utilization of Nafion. However, the co-catalyst 210 utilizes the property where the SO₃H⁻ portion of Nafion acts as a Lewis acid to create hydrophilic characteristics, and can utilize substances containing Lewis acid sites such as HCl, HNO3, carboxylic acids, phenols, alcohols, Li⁺, Mg²⁺, and AlCl₃, which play the same role.

The MOF 260 is a type of coordination polymer, which is a porous material in which metal ions are connected by organic ligands. When a complex of the Lewis acid-containing substance 250 and MOF 260 is utilized as the co-catalyst 210, the Lewis acid-containing substance 250 can be uniformly dispersed throughout the catalyst surface by the MOF 260, and hydrogen gas can easily permeate through the pores of the MOF 260 to minimize catalyst poisoning. In this case, it is preferably desirable to use a MIL-based or UiO-based MOF, and it is also preferably desirable to use a Cr-based or Zr-based MOF.

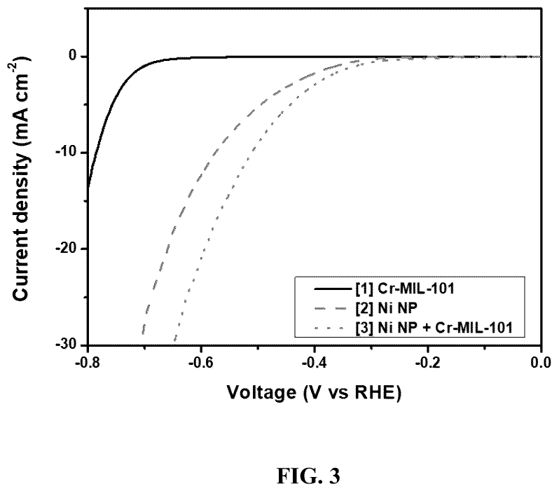

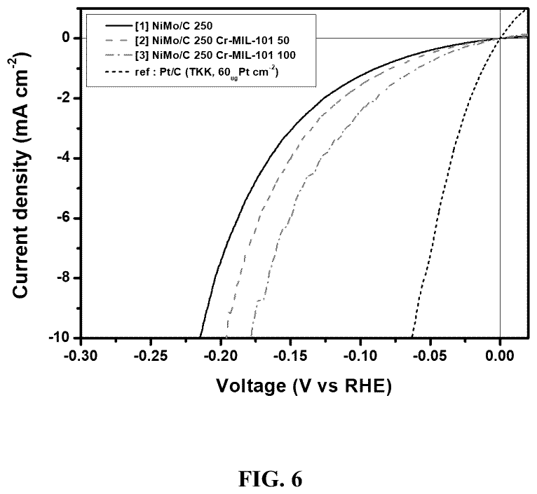

While one embodiment of the present invention utilizes Cr-MIL-101 as MOF 260, experimental results have confirmed that in the case of MOF materials with pore sizes of 6 Å or larger, MOF 250 can promote water dissociation by maximizing the interaction between hydrated cations and the catalyst surface for hydrogen evolution reactions as in the present invention. Referring to FIGS. 3 and 6, examples of MOF material families with pore sizes greater than or equal to 6 Å are illustrated. For example, MOF 250 can be Zr-UiO-66, Ti-MIL-125, Zn-ZIF-69, Zr-UiO-66 octahedral, Zn-ZIF-78, Zn-ZIF-79, Zn-ZIF-81, AL-MIL-53-NH3, Zr-UiO-68, Zn-MOF-74, Zn-ZIF-68, Zn-ZIF-80, Zr-UiO-67, Zn-ZIF-80, Zn-ZIF-82, Al-MIL-53, Zn-ZIF-70, Cu-MOF-74, or Cr-MIL-101.

The catalyst 220 may typically utilize Pt/C, but may also utilize nickel nano powder, NiMo/C, Ni-based catalysts (Ni, Ni compounds, and Ni-based alloy catalysts) used for water electrolysis, Cu-based catalysts (Cu, Cu compounds, and Cu-based alloy catalysts), Co-based catalysts (Co-based alloy or spinel structure catalysts), 3d transition metal catalysts and 3d transition metal-based alloy catalysts, and Pt, Ir catalysts and Pt, Ir-based alloy catalysts. Referring to FIGS. 3 and 6, it is shown that catalyst performance improvement effects are also achieved when using nickel nano powder and NiMo/C as catalysts and Cr-MIL-101 as MOF.

### Method for Making Electrodes for Hydrogen Evolution Reactions

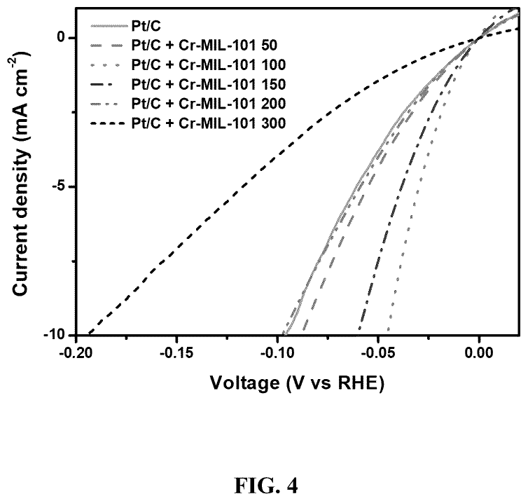

Hereinafter, referring to FIGS. 4 to 8, a method for fabricating an electrode for hydrogen evolution reaction of an alkaline water electrolysis cell according to an embodiment of the present invention will be described in detail.

In an embodiment of the present invention, a complex of Nafion, which is the Lewis acid-containing substance 250, and MOF 260 was used as a co-catalyst 210 for the preparation of an electrode to promote the water dissociation step of the alkaline hydrogen evolution reaction. In the case of Nafion, an ion transfer polymer, it has ionic affinity regions such as SO₃H⁻ groups for cation transfer. Therefore, Nafion has van der Waals attraction with hydrated cations (C⁺—(H₂O)ₓ) in the electrolyte, enabling it to attract hydrated cations close to the catalyst. This maximizes the interaction between the catalyst surface that drives the hydrogen evolution reaction and the hydrated cations, thereby promoting water dissociation.

Furthermore, in the embodiment of the present invention, through the pores of MOF 260 along with Nafion, hydrogen gas generated by the hydrogen evolution reaction could easily permeate and Nafion could be evenly dispersed, thereby implementing the co-catalyst effect across the entire surface while minimizing catalyst poisoning.

According to an embodiment of the present invention, to find the optimal co-catalyst composition, Pt/C catalyst was utilized as a hydrogen evolution reaction catalyst, where the loading amount of Pt was fixed at 20 μg/cm² and the loading amount of Nafion at 10 μg/cm², while the loading amount of Cr-MIL-101, a MOF, was adjusted to perform composition screening.

For this purpose, the electrode fabrication method is as follows.
a. Stirring Nafion solution (DI water: 80 mL/IPA (Isopropyl Alcohol): 20 mL/5 wt % Nafion: 2 mL) at room temperature for 24 hours
b. Disperse Nafion solution according to the ratios of Pt/C to Cr-MIL-101 using tip sonicator (1 hour)
c. 10 μL of a Nafion solution dispersed in Pt/C and Cr-Mil-101 was placed on GC (glassy carbon), dried overnight

The evaluation method and criteria for electrodes made by the above method are as follows.

Construct a three-electrode cell for RDE experiment using the prepared catalyst and measure the HER polarization curve under normal temperature and pressure conditions. Read the potential at a certain current density (10 mA/cm²) from the obtained polarization curve.

### Full Experimental Condition

a. (Working electrode)—RDE (Rotating Disk Electrode)
(Reference electrode)—Hg/HgOl
(Counter electrode)—Pt Wire
b. Electrolyte: 0.1 M KOH (pH 13)
c. Temperature: Room temperature (25° C.)

### HER Activity Evaluation Experiment

a. Purging the electrolyte with hydrogen for 30 minutes
b. Rotate the working electrode at 1600 rpm to remove hydrogen gas from the HER
c. Scan rate: 10 mV/s
d. Scan range: 0.1 V (vs RHE) to −0.5 V (vs RHE)

TABLE 1

| | | Pt: 20 μg/cm² | Pt: 20 μg/cm² | Pt: 20 μg/cm² | Pt: 20 μg/cm² | Pt: 20 μg/cm² |
|---|---|---|---|---|---|---|
| | | Cr-Mil-101: | Cr-Mil-101: | Cr-Mil-101: | Cr-Mil-101: | Cr-Mil-101: |
| Sample | Pt: 20 μg | 50 μg/cm² | 100 μg/cm² | 150 μg/cm² | 200 μg/cm² | 300 μg/cm² |
| η(mV, @10 mA cm⁻²) | 96 | 89 | 45 | 60 | 98 | 195 |

Referring to FIG. 4 and Table 1, when MOF Cr-MIL-101 is loaded, the overpotential gradually begins to decrease and continues to decrease until the ratio of Pt to Cr-MIL-101 reaches 1:5. At the ratio of 1:5 between Pt and Cr-MIL-101, it shows an overpotential of 45 mV, which is significantly lower than the overpotential of the control group Pt/C (96 mV). However, after this point, the overpotential begins to increase again, and when the ratio of Pt to Cr-MIL-101 reaches 1:10, it shows almost the same level of overpotential as before loading Cr-MIL-101, and it was observed that the overpotential increases as the ratio of Cr-MIL-101 increases further. In other words, this experiment confirms that there is a significant improvement in overpotential reduction performance when the loading ratio of Pt: MOF is 1:10 or less.

Meanwhile, to investigate the promotional effect of the Cr-MIL-101 and Nafion co-catalyst composition on the hydrogen evolution reaction, experiments are conducted to confirm: 1) the effects of MOFs other than Cr-MIL-101, and 2) the effects of catalysts other than Pt/C.

### 1) Investigation of the Promotional Effects on Hydrogen Evolution Reaction Using Different MOF Combinations

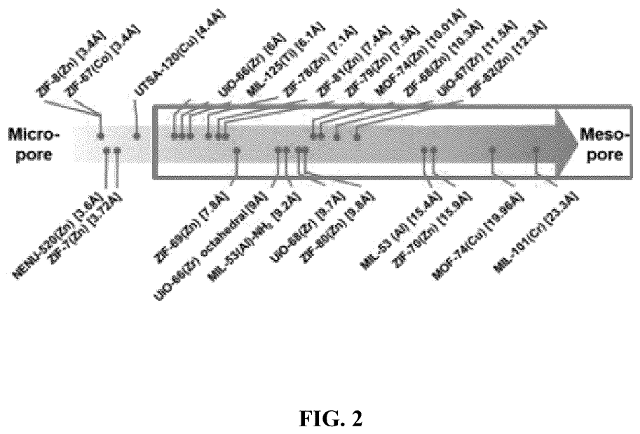

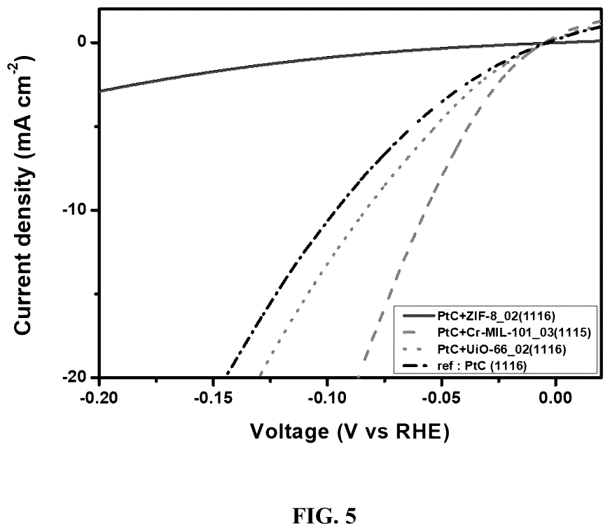

As shown in FIG. 5, electrodes were fabricated using UIO-66 and ZIF-8, representative MOFs other than Cr-MIL-101, applying the previously determined Pt: MOF ratio of 1:5 (following the same electrode fabrication method described earlier for Cr-MIL-101-based electrodes). The evaluation of hydrogen evolution reaction revealed that MOFs other than Cr-MIL-101 showed no significant difference compared to the Pt/C control group. This indicates that the promotional effect is specific to Cr-MIL-101. In this case, the pore size of MOFs plays a crucial role, and as demonstrated in both FIGS. 2 and 5, the hydrogen evolution reaction was enhanced in MOF materials with pore sizes of 6 Å or larger.

### 2) Investigation of the Co-Catalyst Combination Effects on Non-Pt/C Hydrogen Evolution Reaction Catalysts (Non-Precious Metal Catalysts)

As shown in FIG. 6, we investigated the effect of the Cr-MIL-101/Nafion co-catalyst combination on NiMo/C catalyst, a representative non-precious metal catalyst for hydrogen evolution reaction. For this investigation, electrodes were fabricated using NiMo/C catalyst with a fixed loading amount of 250 μg/cm², while varying the Cr-MIL-101 loading at 0, 50, and 100 μg/cm² (the electrode fabrication method remained the same as previously described except for the loading amount, and it should be noted that higher loading amounts can be safely used for non-precious metal catalysts compared to precious metal catalysts). The evaluation of hydrogen evolution reaction using the fabricated electrodes revealed enhanced performance when the Cr-MIL-101 loading amount was 100 μg/cm².

### Alkaline Water Electrolysis Cell

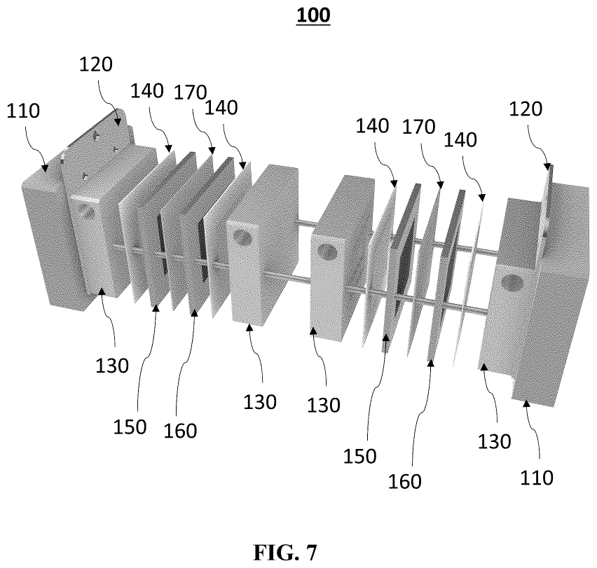

Hereinafter, the stack structure of an Anion Exchange Membrane Water Electrolysis (AEMWE) cell according to an embodiment of the present invention will be described with reference to FIG. 7. FIG. 7 illustrates an alkaline water electrolysis cell comprising electrodes according to an embodiment of the present invention.

As shown in FIG. 7, the AEC cell 100 according to an embodiment of the present invention may comprise an end plate 110, a collector plate 120, an anode plate 130, a porous transport layer 140 (PTL), an anode 150, a cathode 160, and a separator 170. In this embodiment, while the stack of AWE cell 100 is assembled with two zero-gap type single cells, this is merely exemplary, and the stack may be assembled by stacking two or more single cells.

The end plates 110 allow each configuration to be uniformly crimped and engaged by the bolts/nuts when assembling the AEC cell 100, and can protect the anode plate 130, porous transport layer 140, anode 150 and cathode 160, and separator plate when engaged and crimped.

The collector plate 120 can be connected to a power source to supply the entire system with the current (electrons) required for electrolysis.

The bipolar plate 130 has a fluid passage formed inside, through which the electrolyte is supplied, and the nitrogen generated by the oxidation reaction in the cathode and the hydrogen generated by the reduction reaction in the anode are discharged. The bipolar plate 130 may be made of, for example, commercial Ni foam. The bipolar plate is connected to a manifold (not shown) and receives the required electrolyte through the manifold.

The porous transport layer (PTL, 140) may be located outside the electrode to evenly distribute the electrolyte supplied from the separator to the electrode surface and to vent bubble gas generated on the electrode surface to the outside, and may be made of, for example, nickel foam.

The anode 150 and cathode 160 may form a cell voltage via a redox reaction, in which case the anode 150 may be fabricated from, for example, nickel foam, and the fabrication of the cathode 160 in one embodiment of the present invention has been discussed previously.

The separator plate 170 is electrically insulating and acts as a medium for transferring hydroxide (OH⁻) ions during hydrogen production, while also physically separating hydrogen from oxygen. The separator material must be durable in a strongly basic (30% KOH) environment above 80° C. and have low gas permeability to prevent the hydrogen and oxygen gases generated at both electrodes from mixing. At the same time, high ionic conductivity is required. The separator plate 140 may be made of, for example, Zirfon.

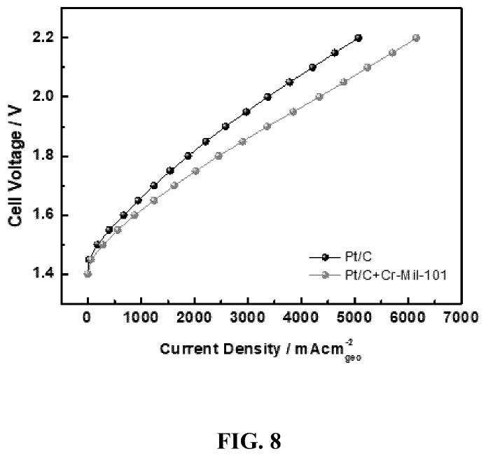

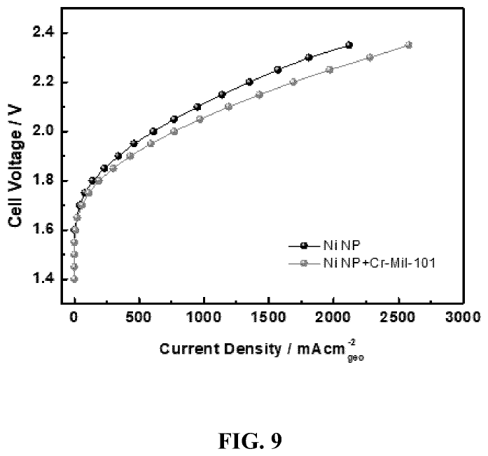

FIGS. 8 to 11 show graphs of the performance evaluation results for a water electrolysis cell according to an embodiment of the present invention in an actual water electrolysis system. As shown in FIG. 8, when Nafion and MOF (Cr-MIL-101) materials are used as co-catalysts for the cathode 160, the performance improves due to increased current density at the same cell voltage. Additionally, as shown in FIG. 9, when using nickel nano powder as an alternative catalyst, the use of Nafion and MOF (Cr-MIL-101) as co-catalysts similarly results in improved performance through increased current density at the same cell voltage.

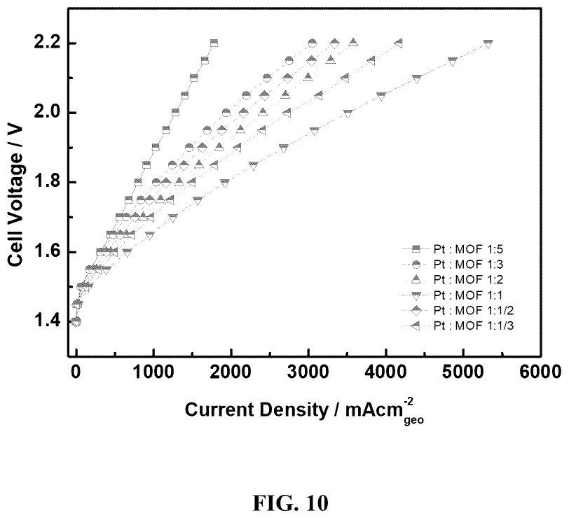

FIG. 10 shows the performance characteristics of different MOF materials in an actual cell. The results demonstrate that the maximum performance enhancement was achieved with a 1:1 loading ratio of Pt:MOF in the actual cell. While the optimal Pt:MOF ratio may vary depending on the system, it was observed that utilizing MOF as a co-catalyst improved performance, but exceeding a certain amount of MOF led to performance deterioration.

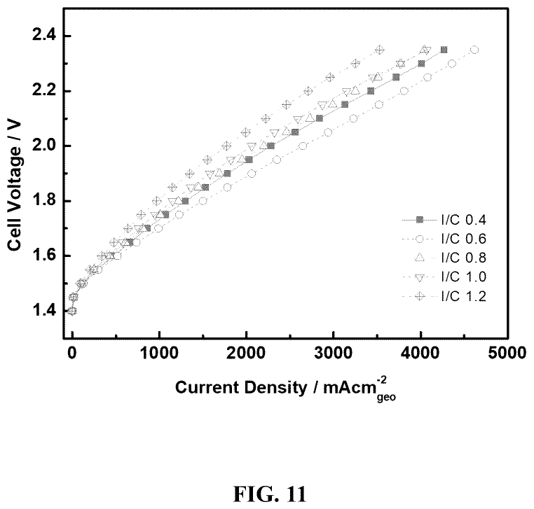

FIG. 11 shows the performance characteristics as a function of Nafion content in electrode implementation according to an embodiment of the present invention in an actual cell. Here, I represents Nafion as the ionomer and C represents carbon, demonstrating the performance variations with respect to the Nafion ratio in the electrode. The results indicate that optimal performance is achieved at an I/C ratio of 0.6. Specifically, when utilizing a composite of Nafion and MOF material as a co-catalyst, the performance increases until the Nafion ratio reaches a certain value, but decreases when the Nafion ratio exceeds this threshold.

Therefore, according to the present invention, we have demonstrated that the Nafion/Cr-MIL-101 co-catalyst combination significantly reduces the overpotential for Pt/C catalysts. This substantially improves the catalytic performance of the hydrogen evolution reaction in alkaline environments, where activation losses are typically higher compared to acidic environments. These improvements are expected to accelerate the commercialization of water electrolysis technology in alkaline environments.

Furthermore, the present invention demonstrates that loading MOF materials other than Cr-MIL-101 can enhance the performance of hydrogen evolution reaction in alkaline water electrolysis cells. Additionally, we have verified that this co-catalyst combination is effective not only with Pt/C catalysts but also with other hydrogen evolution reaction catalysts, thereby providing a universally applicable electrode fabrication method for hydrogen evolution reaction electrodes.

Therefore, the present invention provides an electrode for alkaline hydrogen evolution reaction comprising a composite of Nafion and MOF, which efficiently promotes the water dissociation step of the alkaline hydrogen evolution reaction.

Furthermore, the present invention provides an electrode for alkaline hydrogen evolution reaction that facilitates the permeation of hydrogen gas generated during the hydrogen evolution reaction and enables uniform dispersion of Nafion through the large pores created by MOF, thereby achieving co-catalytic effects across the entire surface while minimizing catalyst poisoning.

Embodiments of the present invention have been described in more detail with reference to the accompanying drawings, but the invention is not necessarily limited to these embodiments and may be practiced in various modifications without departing from the technical idea of the invention. Accordingly, the embodiments disclosed herein are intended to illustrate and not to limit the technical ideas of the invention, and the scope of the technical ideas of the invention is not limited by these embodiments. Therefore, the embodiments described above are exemplary in all respects and should be understood as non-limiting. The scope of protection of the present invention shall be construed in accordance with the following claims, and all technical ideas within the scope thereof shall be construed as falling within the scope of the present invention.

What is claimed is:

1. An electrode for hydrogen evolution reaction of an alkaline water electrolysis cell, comprising:
a co-catalyst comprising a composite including a Lewis acid-containing material and a metal-organic framework (MOF); and
a catalyst surrounded by the co-catalyst.

2. The electrode of claim 1, wherein the Lewis acid-containing material comprises at least one selected from Nafion, HCl, HNO₃, carboxylic acid, phenol, alcohol, Li⁺, Mg²⁺, and AlCl₃.

3. The electrode of claim 1, wherein the metal-organic framework has a pore size of 6 Å or more.

4. The electrode of claim 3, wherein the metal-organic framework is selected from the group consisting of Zr-UiO-66, Ti-MIL-125, Zn-ZIF-69, Zr-UiO-66 octahedral, Zn-ZIF-78, Zn-ZIF-79, Zn-ZIF-81, AL-MIL-53-NH3, Zr-UiO-68, Zn-MOF-74, Zn-ZIF-68, Zn-ZIF-80, Zr-UiO-67, Zn-ZIF-80, Zn-ZIF-82, Al-MIL-53, Zn-ZIF-70, Cu-MOF-74, and Cr-MIL-101.

5. The electrode of claim 1, wherein a mass ratio of the catalyst to the metal-organic framework is 1:10 or less.

6. The electrode of claim 1, wherein the catalyst comprises at least one selected from the group consisting of Pt/C, Nickel Nano powder, NiMo/C, Ni-based catalysts, Cu-based catalysts, and Co-based catalysts.

7. An alkaline water electrolysis cell comprising end plates, current collectors, an anode, a cathode, a porous transport layer, and a separator,
wherein the cathode comprises a co-catalyst comprising a composite including a Lewis acid-containing material and a metal-organic framework (MOF); and
a catalyst surrounded by the co-catalyst.

8. The alkaline water electrolysis cell of claim 7, wherein the Lewis acid-containing material comprises at least one selected from Nation, HCl, HNO₃, carboxylic acid, phenol, alcohol, Li⁺, Mg²⁺, and AlCl₃.

9. The alkaline water electrolysis cell of claim 7, wherein the metal-organic framework has a pore size of 6 Å or more.

10. The alkaline water electrolysis cell of claim 7, wherein the metal-organic framework is selected from the group consisting of Zr-UiO-66, Ti-MIL-125, Zn-ZIF-69, Zr-UiO-66 octahedral, Zn-ZIF-78, Zn-ZIF-79, Zn-ZIF-81, AL-MIL-53-NH3, Zr-UiO-68, Zn-MOF-74, Zn-ZIF-68, Zn-ZIF-80, Zr-UiO-67, Zn-ZIF-80, Zn-ZIF-82, Al-MIL-53, Zn-ZIF-70, Cu-MOF-74, and Cr-MIL-101.

11. The alkaline water electrolysis cell of claim 7, wherein a mass ratio of the catalyst to the metal-organic framework is 1:10 or less.

12. The alkaline water electrolysis cell of claim 7, wherein the catalyst comprises at least one selected from the group consisting of Pt/C, Nickel nano powder, NiMo/C, Ni-based catalysts, Cu-based catalysts, and Co-based catalysts.
